(19) United States
(12) Patent Application Publication
(10) Pub. No.: US 2010/0134499 A1
(43) Pub. Date: Jun. 3, 2010

(54) STROKE-BASED ANIMATION CREATION

(75) Inventors: Hao Wang, Beijing (CN); Kun Yu, Beijing (CN)

Correspondence Address: DITTHAVONG MORI & STEINER, P.C., 918 Prince Street, Alexandria, VA, 22314, US

(73) Assignee: NOKIA CORPORATION, Espoo (FI)

(21) Appl. No.: 12/327,217

(22) Filed: Dec. 3, 2008

(51) Int. Cl. G06T 13/00

(52) U.S. Cl. 345/473

(57) ABSTRACT

A method, apparatus, and computer-readable medium are provided that allow a user to easily generate and play back animation on a computing device. A user can use a mouse, stylus, or finger to draw a stroke indicating a path and speed with which a graphical object should be moved during animation playback. The graphical object may comprise a cartoon character, drawing, or other type of image. In a sequential mode, separate tracks are provided for each graphical object, and the objects move along tracks sequentially (one at a time). In a synchronous mode, graphical objects move along tracks concurrently. Different gestures can be automatically selected for the graphical object at each point along the track, allowing motion to be simulated visually.

### BACKGROUND

With the prevalence of pen-based mobile computing devices such as smart phones, personal digital assistants (PDAs), and palm-sized computers, user expectations for additional features beyond traditional text writing and drawing have increased. The creation of animation is one potential application that could be improved, particularly in relation to devices having small screens, such as pen-based mobile computing devices.

### SUMMARY

This summary is not intended to identify any critical or key elements of the invention, but instead merely presents certain introductory concepts so that the full scope of the invention may be appreciated upon reading the full specification and figures, of which this summary is a part.

Various embodiments of the invention provide a method, apparatus, and computer-readable media having instructions that, when executed, allow a user to easily generate and play back animation on a computing device. A mouse, stylus, or even a user's finger can be used to generate a stroke indicating a path and speed with which a graphical object should be moved during animation playback. In other words, the user's stroke marks the movement of the object to create an animation track. The graphical object may comprise a cartoon character, a user-created graphic, an image captured from a camera, or any other type of graphical object. The stroke may be generated on a touch-sensitive screen using one's finger, or using other types of input device such as a mouse, etc.

A sequential mode provides separate tracks for different objects, wherein only one object at a time moves during playback along a respective track. A synchronous mode allows a user to specify that multiple objects are to be moved simultaneously along separate tracks during playback. The faster the stroke is drawn, the faster the object moves during playback, simplifying the user's animation experience. When the animation is played, each object moves along a path at the speed and direction indicated by the user's stroke.

A mode switching feature may also be provided, permitting a user to switch modes as desired. Elements of sequential and synchronous modes may be combined.

Different gestures can be automatically selected for the graphical object at each point along the track, allowing motion to be simulated visually.

Other embodiments and variations will be apparent upon reading the detailed description set forth below, and the invention is not intended to be limited in any way by this brief summary.

### BRIEF DESCRIPTION OF THE DRAWINGS

FIG. 1 shows features of an animation creation method according to various embodiments of the invention.

FIG. 2 shows automatic selection of an object gesture or orientation based on the tangent of a stroke.

FIG. 3 shows a flowchart including method steps for a mode-switch method of animation creation using strokes.

FIG. 4 shows a flowchart including method steps for a session-based method of animation creation using strokes.

FIG. 5 shows a mode-switch method of animation creation.

FIG. 6 shows a session-based method in which switches are used between time segments.

FIG. 7 shows a motion sequence for the animations of FIG. 5 and 6.

FIG. 8 shows a compound method combining the mode-switching and session-based techniques for the same animation setting.

FIG. 9 shows an exemplary computing device in which various principles of the invention may be practices.

### DETAILED DESCRIPTION

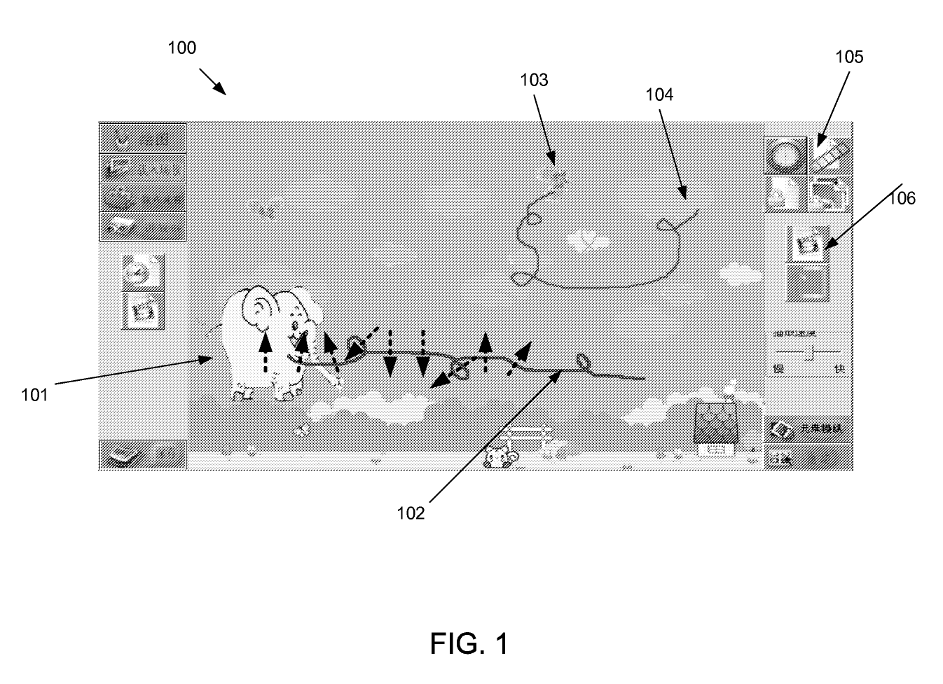

FIG. 1 shows features of an animation creation method according to various embodiments of the invention. An animation creation mode is provided in which a user can create one or more animation tracks for graphical objects. An animation playback mode can also be provided, allowing one or more graphical objects to move according to the animation tracks created during the animation creation mode. The method may be practiced on a computing device including one or more processors, memories, displays, and user input devices as described in more detail herein.

As shown in FIG. 1, a user interface 100 includes a display (e.g., a touch-sensitive screen, a conventional computer display, or any other type of display capable of showing graphical objects) on which is displayed a first graphical object 101 and a first animation track 102. According to various embodiments, a user can use a stylus, mouse, finger, or any other input mechanism to generate a stroke corresponding to animation track 102, which indicates the path, orientation, and speed that the graphical object should take as it traverses the animation track upon playback. As the user marks the stroke, the computing device detects the path and speed associated with the user's stroke and stores this information in one or more memories. When the stroke ends (e.g., the user lifts the stylus or releases a mouse button), the computing device marks the end of the corresponding animation track in the memory. Upon further input from the user, such as by selecting a playback icon 105, the animation may be played back, causing the graphical object to follow the path and speed corresponding to the stroke generated by the user during animation creation. Various means for receiving a stroke indicating a path for the graphical object may include a touch-sensitive display (with or without a stylus), a mouse in combination with a computer display, or a display device in combination with one or more buttons or other electromechanical switches joystick, roller knobs, etc.).

The speed at which the graphical object travels upon playback need not be identical to the speed at which the stroke was drawn, but it can instead be derived from it as a function of, for example, a multiplication or addition factor. Accordingly, the computing device may more generally store any information indicating a speed at which the graphical object is intended to travel upon playback. One approach for providing such information is to repeatedly sample the movement of the stroke and to record the time at which each sample occurs with reference to a timing signal or timeline. Other approaches are of course possible. Sampling may allow varying time segments to be created easily (e.g., slower and faster time segments can be easily generated and combined into a single track). Alternatively, an animation sequence may be played at a constant rate based on the total time to input a stroke divided by the length of the stroke, and using the optional multiplication or addition factor described above.

Any of various means for storing information regarding the path and information indicating a speed at which the graphical object is intended to travel may be used, including one or more memories, a processor and associated memory, custom circuitry (e.g., an application-specific integrated circuit or field-programmable gate array), or combinations thereof.

In a first animation creation mode, referred to herein as a sequential animation mode, separate tracks are created for separate graphical objects, such that during playback only one object at a time moves along its respective path—i.e., the movement of each graphical object occurs sequentially. When a first object has finished moving along its path, the next object moves along its respective path, and so on. As shown in FIG. 1, for example, a second graphical object 103 moves along a second path 104, previously created by a user. When playing back the tracks in sequential animation mode, first the elephant graphical object 101 moves along track 102 at a speed corresponding to the speed with which the user created track 102. Next, the butterfly graphical object 103 moves along track 104 at a speed corresponding to the speed with which the user created track 104. After the tracks have been created, a playback button 105 can be selected to cause the animation of the graphical objects. A mode selector (not shown) allows the user to select the sequential animation mode, or such a mode can be provided by default.

In one variation, the orientation of the graphical object is automatically matched by the computing device to the orientation of the path, so that (for example) as the path turns a corner, so does the graphical object upon animation playback. In FIG. 1, this is indicated schematically by dashed thick arrows along path 102 pointing generally in a direction perpendicular to the path, indicating the orientation of elephant 101 as it traverses the path. At three points along the path, the orientation turns upside down (corresponding to the three loops in path 102) so the elephant would be upside down for portions of the track. Other variants of this are also possible, e.g., the path might only indicate a current position of the graphical object, while maintaining a constant orientation.

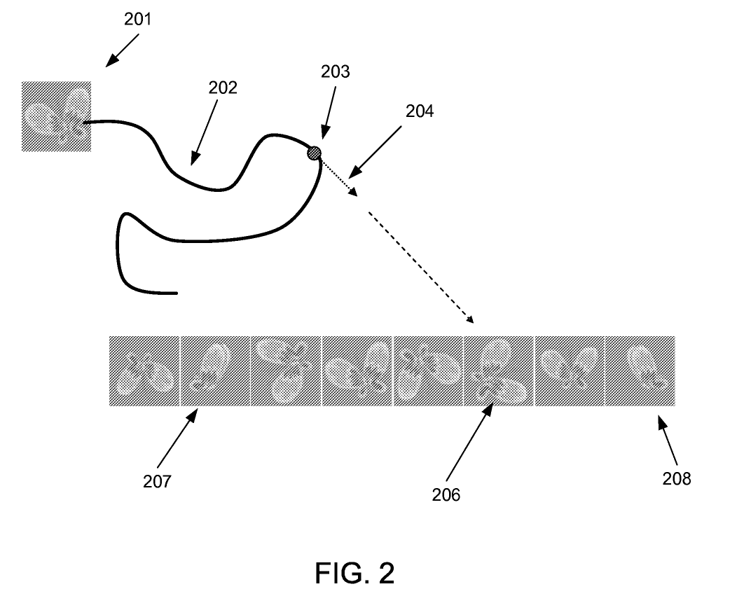

Turning briefly to FIG. 2, in some embodiments the orientation or gesture of the graphical object along the path is automatically selected based on the tangent of the stroke made by the user. For example, an upright orientation of the butterfly object 201 may be automatically selected when the user begins the stroke. As the user moves the stylus or other input device along a path 202, a tangent 204 of the stroke is repeatedly calculated by the computing device. The tangent can be used by the computing device to automatically select from one of a plurality of pre-stored orientations or gestures of the graphical object. As shown in FIG. 2, for example, when the stroke reaches sampling point 203, a tangent 204 is calculated, indicating that a corresponding orientation or gesture 206 of the graphical object should be selected for display at that point when the animation is played back. Additionally, a different gesture 207 of the graphical object may indicate motion by the graphical object, such as the butterfly flapping its wings, or the feet or limbs of a different graphical object moving to simulate motion. As used herein, the word “orientation” refers generally to a rotational aspect of a graphical object, and the word “gesture” refers generally to a configuration aspect of a graphical object, such as the flapping of wings or different foot or arm position.

In some variations, a different gesture for the graphical object can be automatically selected as the object moves along a track so as to simulate motion by the graphical object (e.g., wing flapping or walking), in combination with selecting an orientation corresponding to the tangent of the stroke. In FIG. 2, two different closed-wing gestures 207 and 208 are shown. Gesture 207 corresponds to a closed-wing configuration when the stroke moves from left to right, whereas gesture 208 corresponds to a closed-wing configuration when the stroke moves from right to left. For example, as the graphical object traverses the path corresponding to the stroke, for every other position along the path, one of the closed-wing gestures of the graphical object could be selected during playback, interleaved with the different open-winged gestures of the graphical object, in order to simulate the flapping of wings as the object moves along the path. Many variations are of course possible and the invention is not limited in this respect.

In some embodiments, during the animation creation mode only the stroke made by the user is displayed on the screen, whereas in other embodiments, during the animation creation mode the specific orientation and gesture automatically selected by the computing device for the corresponding position on the path are dynamically displayed as the user makes the stroke, permitting the user to better visualize how the animation will appear when it is played back.

In a second animation mode, referred to herein as a synchronous mode, the user can specify that multiple graphical objects are to be moved synchronously along respective paths during playback. Each mode (sequential and synchronous) may be selected by way of a graphical icon or other input such as a soft or hard button. For paths that are designated as being synchronous in nature, the animation of such paths may begin synchronously, even if the paths are not identical in length. In one variation, the animation of such tracks begins at the same time, and each track progresses at the rate at which it was created—i.e., the animation along each track may proceed at different rates from other tracks, such that they start and end at the same time. In other variations, the animation of each track begins synchronously, and each track proceeds independently based on the speed with which the stroke was drawn, meaning that the two tracks may not necessarily end at the same time. Alternatively, the duration of each animation may be pre-calculated, and each animation may begin at a different time such that each animation ends at the same time.

It is also within the scope of the invention to combine the synchronous and sequential modes, such that some animation tracks are played sequentially while others are played synchronously. In this variation, the user may indicate what type of mode is desired and can switch between modes during animation creation. The user may designate (e.g., by clicking or otherwise highlighting) which animation tracks are to be synchronously played and which are not.

Any of various means for providing an animation playback mode as described herein may be used, including one or more processors with associated memory programmed to perform steps as described herein, specialized circuitry (e.g., an application-specific integrated circuit or field-programmable gate array programmed to perform steps as described herein), or combinations thereof, and may be combined with the means for storing information regarding the path and information indicating a speed at which the graphical object is intended to travel.

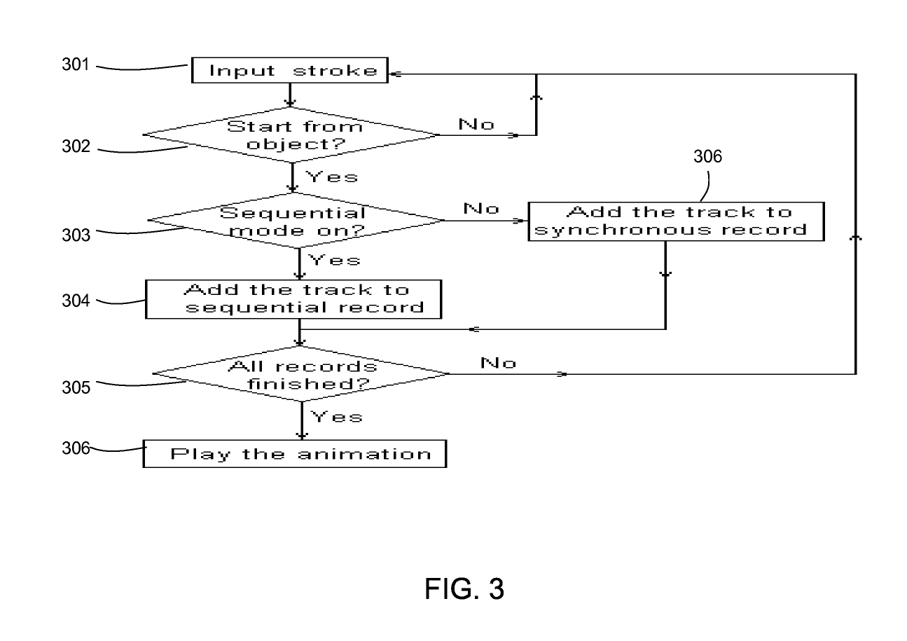

FIG. 3 shows a flowchart including method steps for a mode-switch method of animation creation using strokes. In step 301, a stroke is received from an input device, such as via a stylus or mouse, or a finger on a touch-sensitive screen. In step 302, it is determined whether the stroke started from a graphical object on a display. It is assumed that the user previously selected or drew a graphical object on the display (not shown in FIG. 3), such as a cartoon, an image, a photograph, or any other type of graphical object. If in step 302 the computing device determines that the stroke did not originate from an object, the method returns to step 301.

If the stroke originated from a graphical object, then in step 303 it is determined whether the sequential mode of animation is activated. If the sequential mode is activated, then in step 304 the track corresponding to the stroke is added to a sequential track record in memory, whereas if the sequential mode is not activated, in step 306 it is assumed that synchronous mode was active and the stroke is added to a synchronous record in memory. Although not specifically shown in FIG. 3, in addition to recording the stroke (i.e., the path taken by the stylus or other input device), the speed at which the stroke was drawn can also be recorded, or times corresponding to sampling points along the path can be recorded. This can be done by sampling the input at fixed time intervals and recording the time that the stroke takes to move from sampling point to sampling point. In step 305, it is determined whether all records are finished, such as by user input indicating that the record is completed. In step 306, the animation can be played back as explained above.

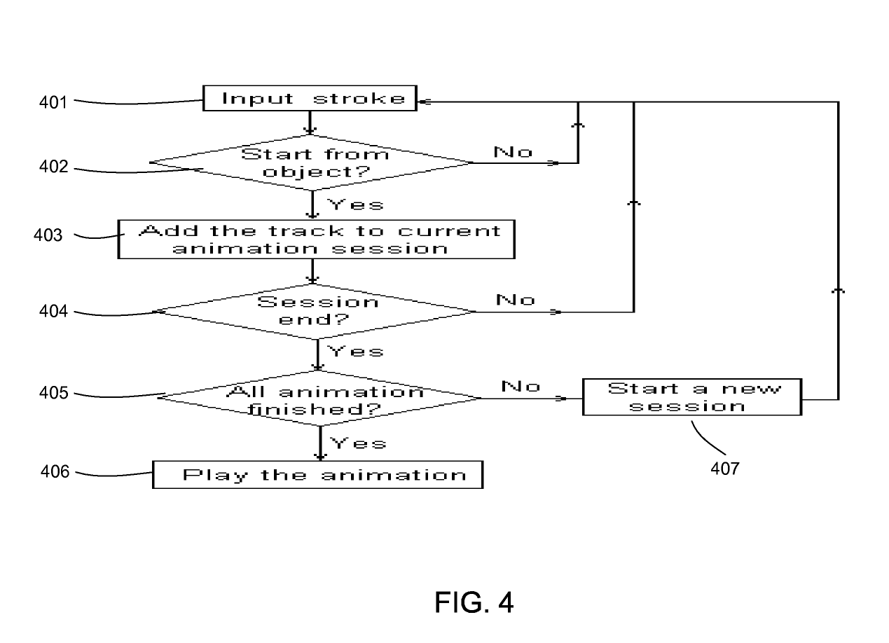

FIG. 4 shows a session-based method of animation creation according to certain variations of the invention. In this method, the movement of graphical objects is performed at a session level. Each session is designated for either synchronous playback or sequential playback. A cut button (FIG. 1, element 106) can be used to end one session of movements while starting another. All the animation strokes made between two pressings of the cut button are recorded as part of the same session, and hence the user can arrange synchronous movements within one session and sequential movements within a different session. There may be multiple sequential sessions and/or multiple synchronous sessions as desired. Beginning in step 401, an input stroke is received in a computing device. In step 402, it is determined whether the stroke started from a graphical object. (As above, it is assumed that the graphical object was previously selected or generated on the display). If the stroke did not originate from a graphical object, the process reverts to step 401 until another stroke is entered. If the stroke started from a graphical object, then in step 403 the track or path corresponding to the stroke is added to the current animation session. (If no session yet exists, one can be created).

In step 404 a check is made to determine whether the user chose to end the sessions, for example by pressing a cut button 106 as illustrated in FIG. 1. If the session did not end, the process returns to step 401 until another stroke is input, and the process repeats, adding animation tracks to the current session (which indicates that all tracks in the session are to be synchronized upon playback). If in step 404 the user chose to end the session, then in step 405 a check is made to determine whether all animation is finished (e.g., by user input). If not, then in step 407 a new session is started and the process repeats at step 401. When all animation is completed, then in step 406 the animation can be played back. As explained above, in certain variations, all tracks contained within the same session may be synchronized (i.e., started at the same time, ending at the same time, etc.), whereas tracks contained in different sessions are sequentially played. This approach allows the user to quickly and easily create combinations of synchronized and sequential movement of graphical objects.

In certain embodiments, color coding can be used such that a different color is used for different tracks, providing visual cues for the user. In some embodiments, the thickness of the tracks can be changed depending on the animation mode, such that for example a thin track corresponds to sequential movement of objects, whereas a thick track corresponds to synchronous movement of objects.

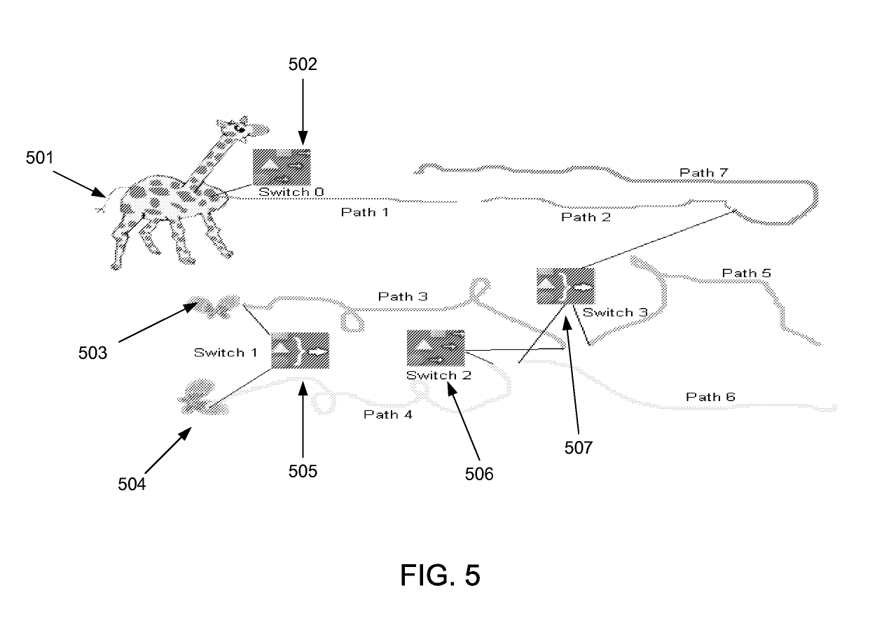

FIG. 5 illustrates a mode-switching method of animation creation according to various embodiments. A user selects a mode switch 502 (e.g., by clicking a graphical icon) to indicate sequential session, and then draws a stroke corresponding to path 1 for graphical object 501. A next stroke corresponding to path 2 is also drawn. The user then selects mode switch 505 (e.g., by clicking an icon corresponding to mode switch 505) to toggle to a synchronous session, and the computing device then creates two synchronous tracks (path 3 and path 4) corresponding to graphical objects 503 and 504 respectively. As shown in FIG. 5, the width of paths 3 and 4 is shown on the display device as being wider than path 1, which is a sequential track. The user then selects mode switch 506 to toggle to a new sequential session, and immediately selects mode switch 507 to toggle back to a new synchronous session. The user then draws paths 5, 6, and 7, indicating that those three tracks should be animated in synchronization. FIG. 5 illustrates an embodiment that toggles between session types with each new session, as illustrated by the concurrent toggling 506 and 507 to obtain two back-to-back synchronous sessions. However, in alternative embodiments, a user might be required to specify a session type each time a new session is created, rather than toggling between session types, thereby eliminating the back-to-back toggling illustrated in FIG. 5.

In FIG. 5, after creation of the tracks as shown, the animation proceeds as follows: First, the giraffe 501 moves along path 1, then it moves along path 2. After that, the giraffe stops, while both butterflies 503 and 504 fly synchronously along paths 3 and 4 respectively. Then the butterflies fly along paths 5 and path 6 while the giraffe moves along path 7 (i.e., the two butterflies move in synchronization or concurrently with the giraffe).

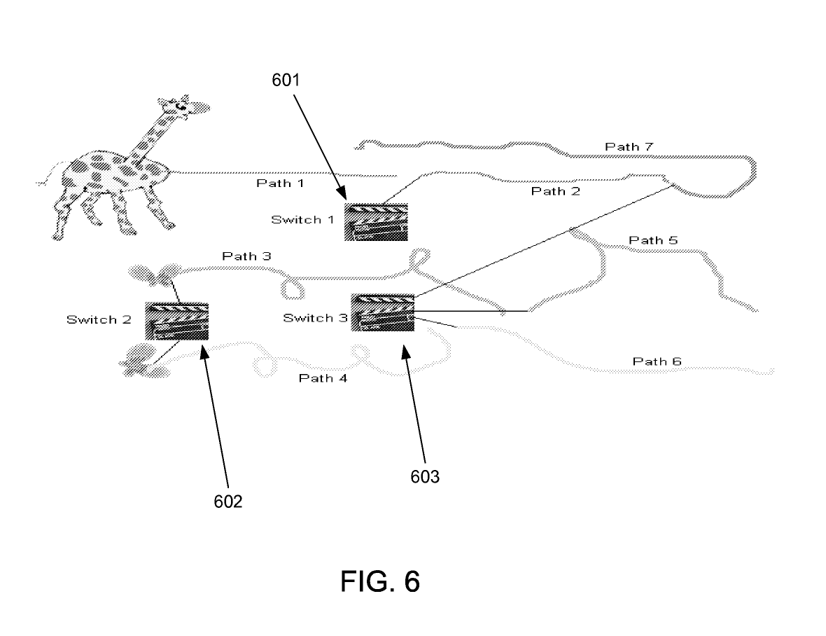

FIG. 6 shows a session-based method in which switches are used between time segments. In FIG. 6, after drawing a stroke for path 1, the user selects cut switch 601 to indicate the end of the first session, then draws path 2. Thereafter, the user selects cut switch 602 to indicate the start of a new session, during which strokes for paths 3 and 4 are drawn, indicating that they are to run synchronously. Thereafter, the user selects cut switch 603, indicating the start of a new session in which paths 5, 6, and 7 are drawn, indicating that they should run synchronously. The animation effect is the same as with FIG. 5.

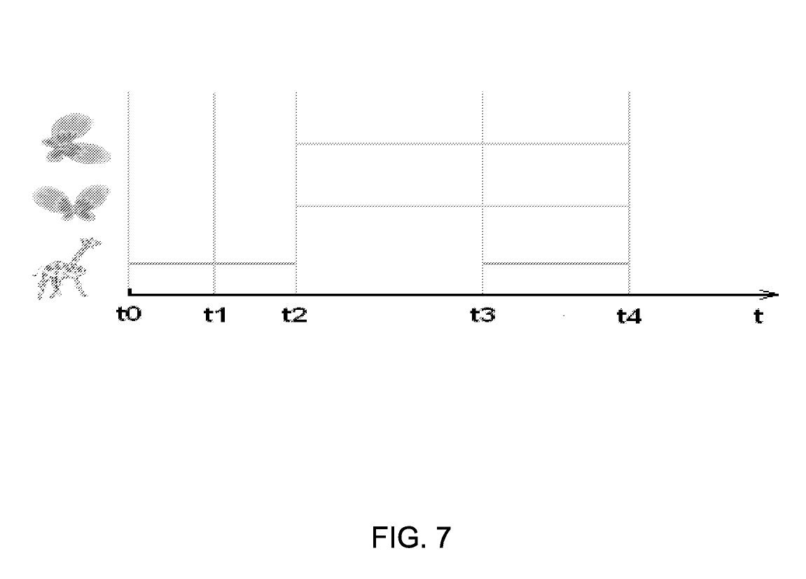

FIG. 7 shows a motion sequence for the animations of FIG. 5 and 6. As shown in FIG. 7, first the giraffe moves from t0 to t1 and t2. Then, at time t2, the two butterflies move in synchronization until time t3. At time t3, the giraffe also moves in synchronization with the two butterflies from t3 to t4.

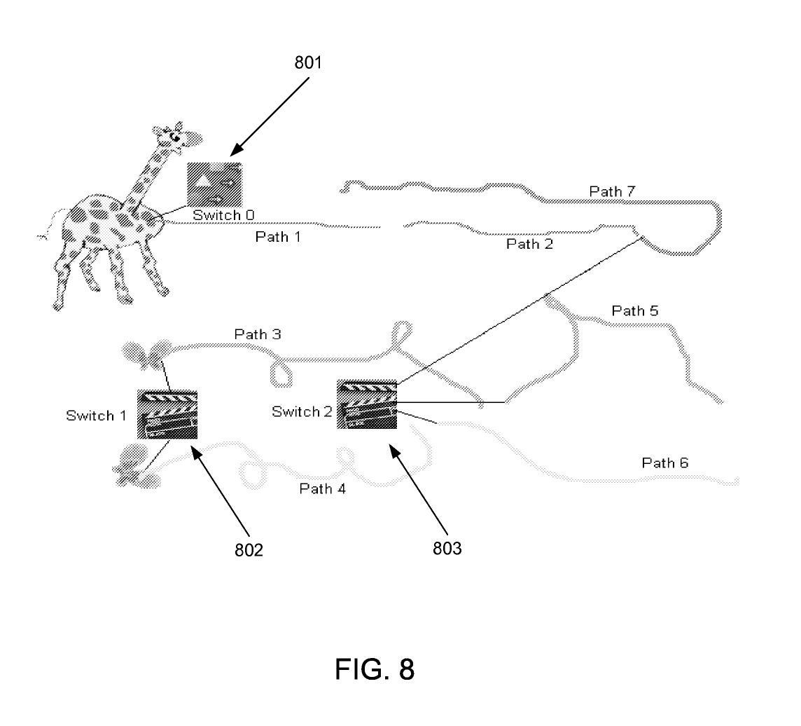

FIG. 8 shows a compound method combining the mode-switching and session-based techniques for the same animation setting. In FIG. 8, a mode switch 801 indicates sequential mode for drawing paths 1 and 2. Selecting cut button 802 indicates that a new session is to start, corresponding to paths 3 and 4. Again selecting cut button 803 indicates that another session is to begin, including paths 5, 6, and 7.

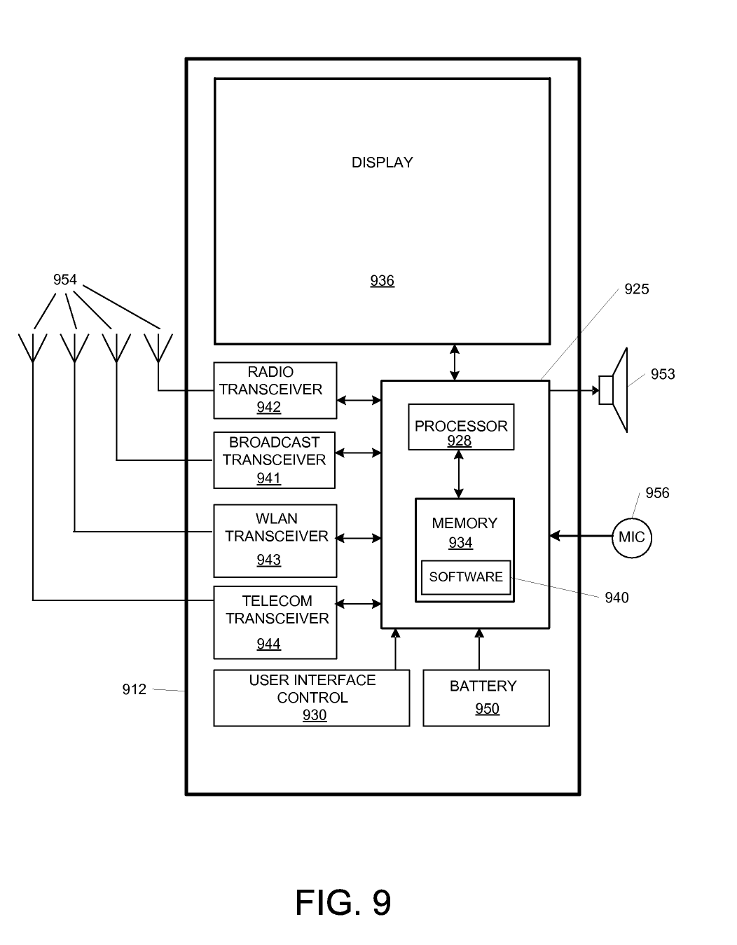

FIG. 9 illustrates an exemplary computing device, such as a mobile terminal, that may be used to carry out various principles of the invention. Device 912 may include a controller 925 coupled to a user interface controller 930, display device 936, and other elements as illustrated. Controller 925 may include one or more processors or other circuitry 928 (including one or more integrated circuits or chipsets) configured to perform any of the steps described herein, and memory 934 storing software 940 that may be used to perform the steps in connection with processors or circuitry 928. Device 912 may also include a battery 950, speaker 952 and antenna 954. User interface controller 930 may include controllers, adapters, and/or circuitry configured to receive input from or provide output to a keypad, touch screen, voice interface (e.g. via microphone 956), function keys, joystick, data glove, mouse and the like.

Computer executable instructions and data used by processor 928 and other components of device 912 may be stored in a storage facility such as memory 934. Memory 934 may comprise any type or combination of read only memory (ROM) modules or random access memory (RAM) modules, including both volatile and nonvolatile memory such as disks. Software 940 may be stored within memory 934 to provide instructions to processor 928 such that when the instructions are executed, processor 928, device 912 and/or other components of device 912 are caused to perform various functions or methods including those described herein. Software may include both applications and operating system software, and may include code segments, instructions, applets, pre-compiled code, compiled code, computer programs, program modules, engines, program logic, and combinations thereof. Computer executable instructions and data may further be stored on computer readable media including electrically erasable programmable read-only memory (EEPROM), flash memory or other memory technology, CD-ROM, DVD or other optical disk storage, magnetic cassettes, magnetic tape, magnetic storage and the like. The term “memory” as used herein includes both a single memory as well as a plurality of memories of the same or different types.

Device 912 or its various components may be configured to receive, decode and process various types of transmissions including digital broadband broadcast transmissions that are based, for example, on the Digital Video Broadcast (DVB) standard, such as DVB-H, DVB-H+, or DVB-MHP, through a specific broadcast transceiver 941. Other digital transmission formats may alternatively be used to deliver content and information of availability of supplemental services. Additionally or alternatively, device 912 may be configured to receive, decode and process transmissions through FM/AM Radio transceiver 942, wireless local area network (WLAN) transceiver 943, and telecommunications transceiver 944. Transceivers 941, 942, 943 and 944 may, alternatively, include individual transmitter and receiver components.

One or more aspects of the invention including the method steps described herein may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), application specific integrated circuits (ASIC), and the like. The terms “processor” and “memory” comprising executable instructions should be interpreted individually and collectively to include the variations described in this paragraph and equivalents thereof.

Embodiments include any novel feature or combination of features disclosed herein either explicitly or any generalization thereof. While embodiments have been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

What is claimed is:

1. A method comprising:
receiving from an input device a stroke indicating a path along which a graphical object is intended to travel;
storing, into a memory, path information identifying a path of travel of the graphical object and speed information indicating a speed at which the graphical object is intended to travel along the path, wherein the speed at which the graphical object is intended to travel is derived from a corresponding speed at which the stroke was drawn; and
providing an animation playback mode in which the graphical object moves along the path at the speed at which the graphical object is intended to travel.

2. The method of claim 1, wherein the stroke is received from a touch-sensitive display device.

3. The method of claim 1, wherein the path is a non-linear path.

4. The method of claim 1, wherein in the animation playback mode, at each of a plurality of points along the path, the graphical object is automatically depicted with an orientation corresponding to an orientation of the stroke at each respective point.

5. The method of claim 1, further comprising automatically selecting a gesture of the graphical object at each of a plurality of points along the path, wherein a plurality of different gestures are associated with the path.

6. The method of claim 5, wherein in the animation playback mode, the graphical object at each respective point is depicted using a gesture corresponding to one of the plurality of different gestures.

7. The method of claim 5, wherein each respective gesture is selected on the basis of a sampling tangent at each respective point along the path corresponding to the stroke.

8. The method of claim 1, further comprising:
providing a sequential animation creation mode wherein each of a plurality of graphical objects is assigned to a different path corresponding to a respective stroke, and
wherein in the animation playback mode each of the plurality of graphical objects is moved sequentially along a corresponding different path, such that only one graphical object at a time moves.

9. The method of claim 1, further comprising:
providing a synchronous animation creation mode wherein each of a plurality of graphical objects is assigned to a different path corresponding to a respective stroke, and
wherein in the animation playback mode each of the plurality of graphical objects is moved in synchronization with the other graphical objects, such that a plurality of graphical objects move simultaneously.

10. The method of claim 1, further comprising displaying the graphical object in motion along the path as the stroke is received.

11. The method of claim 1, further comprising:
repeating said receiving and storing for each of a plurality of different graphical objects and automatically synchronizing the respective paths for each graphical object for all paths generated within a session.

12. An apparatus comprising:
a processor; and
a memory storing executable instructions that, when executed by one or more components of the apparatus, configure the apparatus to perform:
receiving from an input device a stroke indicating a path along which a graphical object is intended to travel;
storing, into the memory, path information identifying a path of travel of the graphical object and speed information indicating a speed at which the graphical object is intended to travel along the path, wherein the speed at which the graphical object is intended to travel is derived from a corresponding speed at which the stroke was drawn; and
providing an animation playback mode in which the graphical object moves along the path at the speed at which the graphical object is intended to travel.

13. The apparatus of claim 12, further comprising a touch-sensitive display coupled to the processor and configured to receive the stroke and to display the graphical object in the animation playback mode.

14. The apparatus of claim 12, wherein the instructions when executed cause the apparatus to receive the stroke as a non-linear path.

15. The apparatus of claim 12, wherein the instructions, in the animation playback mode, at each of a plurality of points along the path, cause the graphical object to be automatically depicted with an orientation corresponding to an orientation of the stroke at each respective point.

16. The apparatus of claim 12, wherein the instructions, when executed, automatically select a gesture of the graphical object at each of a plurality of points along the path, wherein a plurality of different gestures are associated with the path.

17. The apparatus of claim 16, wherein the instructions, in the animation playback mode, cause the graphical object at each respective point to be depicted using a gesture corresponding to one of the plurality of different gestures.

18. The apparatus of claim 16, wherein the instructions, when executed, cause each respective gesture to be selected on the basis of a sampling tangent at each respective point along the path corresponding to the stroke.

19. The apparatus of claim 12, wherein the instructions, when executed, cause the apparatus to perform:
providing a sequential animation creation mode wherein each of a plurality of graphical objects is assigned to a different path corresponding to a respective stroke, and
wherein in the animation playback mode each of the plurality of graphical objects is moved sequentially along a corresponding different path, such that only one graphical object at a time moves.

20. The apparatus of claim 12, wherein the instructions, when executed, cause the apparatus to perform:
providing a synchronous animation creation mode wherein each of a plurality of graphical objects is assigned to a different path corresponding to a respective stroke, and
wherein in the animation playback mode each of the plurality of graphical objects is moved in synchronization with the other graphical objects, such that a plurality of graphical objects move simultaneously.

21. The apparatus of claim 12, wherein the instructions, when executed, cause the apparatus to perform displaying the graphical object in motion along the path as the stroke is received.

22. The apparatus of claim 12, wherein the instructions, when executed, cause the apparatus to perform:
repeating the receiving and storing steps for each of a plurality of different graphical objects and automatically synchronizing the respective paths for each graphical object for all paths generated within a session.

23. One or more computer-readable media having stored thereon executable instructions that, when executed, perform:
receiving from an input device a stroke indicating a path along which a graphical object is intended to travel;
storing, into a memory, path information identifying a path of travel of the graphical object and speed information indicating a speed at which the graphical object is intended to travel along the path, wherein the speed at which the graphical object is intended to travel is derived from a corresponding speed at which the stroke was drawn; and
providing an animation playback mode in which the graphical object moves along the path at the speed at which the graphical object is intended to travel.

24. The one or more computer-readable media of claim 23, wherein the instructions when executed perform receiving the stroke from a touch-sensitive display device.

25. The one or more computer-readable media of claim 23, wherein the instructions when executed perform receiving the stroke as a non-linear path.

26. The one or more computer-readable media of claim 23, wherein the instructions when executed, perform:
in the animation playback mode, at each of a plurality of points along the path, automatically depicting the graphical object with an orientation corresponding to an orientation of the stroke at each respective point.

27. The one or more computer-readable media of claim 23, wherein the instructions when executed, perform:
automatically selecting a gesture of the graphical object at each of a plurality of points along the path, wherein a plurality of different gestures are associated with the path.

28. The one or more computer-readable media of claim 27, wherein in the animation playback mode, the instructions cause the graphical object at each respective point to be depicted using a gesture corresponding to one of the plurality of different gestures.

29. The one or more computer-readable media of claim 27, wherein the instructions when executed, cause each respective gesture to be selected on the basis of a sampling tangent at each respective point along the path corresponding to the stroke.

30. The one or more computer-readable media of claim 23, wherein the instructions, when executed, perform:
providing a sequential animation creation mode wherein each of a plurality of graphical objects is assigned to a different path corresponding to a respective stroke, and
wherein in the animation playback mode each of the plurality of graphical objects is moved sequentially along a corresponding different path, such that only one graphical object at a time moves.

31. The one or more computer-readable media of claim 23, wherein the instructions, when executed, perform:
providing a synchronous animation creation mode wherein each of a plurality of graphical objects is assigned to a different path corresponding to a respective stroke, and
wherein in the animation playback mode each of the plurality of graphical objects is moved in synchronization with the other graphical objects, such that a plurality of graphical objects move simultaneously.

32. The one or more computer-readable media of claim 23, wherein the instructions, when executed, perform:
displaying the graphical object in motion along the path as the stroke is received.

33. The one or more computer-readable media of claim 23, wherein the instructions, when executed, perform:
repeating the receiving and storing steps for each of a plurality of different graphical objects and automatically synchronizing the respective paths for each graphical object for all paths generated within a session.

34. An apparatus comprising:
means for receiving a stroke indicating a path along which a graphical object is intended to travel;
means for storing path information identifying a path of travel of the graphical object and speed information indicating a speed at which the graphical object is intended to travel along the path, wherein the speed at which the graphical object is intended to travel is derived from a corresponding speed at which the stroke was drawn; and
means for providing an animation playback mode in which the graphical object moves along the path at the speed at which the graphical object is intended to travel.
